(19) United States
(12) Patent Application Publication
(10) Pub. No.: US 2006/0194537 A1
(43) Pub. Date: Aug. 31, 2006

(54) System and method for underwater data communication

(76) Inventor: Kim McCoy, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/364,688

(22) Filed: Feb. 27, 2006

Related U.S. Application Data
(60) Provisional application No. 60/657,550, filed on Feb. 28, 2005.

(51) Int. Cl. H04B 13/02

(52) U.S. Cl. 455/40

(57) ABSTRACT

Embodiments include an underwater communications device and methods of using and operating such devices. For example, an underwater communications device may include a radiative element, a communications section comprising at least one of a receiver and a transmitter. The radiative element communicates RF signals associated with the communications module. The system further includes an at least partially nonmetallic housing to enclose the radiative element and the communications section.

### CROSS-REFERENCE TO RELATED APPLICATIONS

This application claims the benefit of, and incorporates by reference in its entirety, U.S. Provisional Application No. 60/657550, filed Feb. 28, 2005.

### BACKGROUND OF THE INVENTION

1. Field of the Invention

The invention relates to non-contact underwater communication, and in particular, to RF signal transmission of high data rates over short ranges.

2. Description of the Related Technology

Communication methods used underwater are significantly different than those used elsewhere. The dominant above water techniques are radio frequency (RF) and light frequency transmission methods. Both of these methods suffer from attenuation and scattering underwater. The result of scattering and attenuation is limited propagation distances. The underwater scattering of light results primarily from the particulate matter suspended in water. The attenuation of radio waves underwater results primarily from the elevated dielectric constant of water (˜80) as compared to that of air (˜1). Hence, most underwater communication techniques have eschewed using radio and light based methods in favor of acoustic methods.

Nevertheless, although highly attenuated compared to air, radio waves do propagate underwater. Maxwell's equations are used to describe the propagation of electromagnetic waves in any medium. Underwater propagation distances and speeds vary due to numerous factors including the temperature and the electrical conductivity of water. Seawater has an electrical conductivity several thousand times (˜4000) that of fresh water however Maxwell's equations are applicable to both types of water and other aqueous and non-aqueous solutions.

Radio wave attenuation increases with frequency. Very Low Frequencies (VLF) have been used for decades for submarine communication purposes because of their lower relative attenuation underwater. Historically, underwater radio transmissions have been at frequencies well below 1 kHz and typified by long range propagation and low data rates.

### SUMMARY OF CERTAIN INVENTIVE ASPECTS

One aspect of the invention is an underwater communications device, comprising a radiative element, a communications section comprising at least one of a receiver and a transmitter, wherein the radiative element communicates RF signals associated with the communications module, and an at least partially nonmetallic housing to enclose the radiative element and the communications section.

Another aspect of the invention is an underwater communications device, comprising a radiative element, a communications module comprising at least one of a receiver and a transmitter, wherein the radiative element communicates RF signals associated with the communications section, and an at least partially nonmetallic housing to enclose the radiative element and the communications module, wherein the communications module provides relatively high speed data for short range transmission.

Yet another aspect of the invention is an underwater communications device, comprising a radiative element, a modem, wherein the radiative element communicates RF signals associated with the modem, and an at least partially nonmetallic housing to enclose the radiative element and the modem.

Various aspects may include one or more of: wherein the RF signals are propagated through the water at UHF or higher frequencies; wherein the RF signals are propagated through the water at from about 10 kHz to about 10 GHz; wherein the RF signals are communicated to another device located within about a 30 cm radius; wherein the communications section is a transceiver; wherein the housing is at least partially formed from plastic; wherein the housing is at least partially formed from Delrin or PVC; additionally comprising an interface for communicating data to a processing device and wherein the processing device is located internally to the housing or externally in a host.

Another aspect of the invention is a method of underwater data communication, comprising transmitting an RF signal within a housing, wherein the transmitted RF signal propagates in water, and wherein a relatively high data rate is received from the RF signal over a short range.

One more aspect of the invention is a method of underwater data communication, comprising receiving an RF signal within a housing, wherein the received RF signal propagates in water, and wherein a relatively high data rate is transmitted on the RF signal over a short range.

The invention may be characterized by further aspects and embodiments than those provided above.

### BRIEF DESCRIPTION OF THE DRAWINGS

FIG. 1 is a block diagram illustrating a pair of communications devices according to one embodiment of the invention.

FIG. 2 is a block diagram illustrating a pair of communications devices according to another embodiment of the invention.

FIG. 3 is an exploded mechanical view of the main components of one embodiment of the invention.

### DETAILED DESCRIPTION OF THE CERTAIN INVENTIVE EMBODIMENT

The following describes various embodiments of the inventive system and method for underwater data communication. While various details of embodiments of the technology may be provided below, the invention generally encompasses a broad variety of options in its implementations, none of which should be considered to limit the invention.

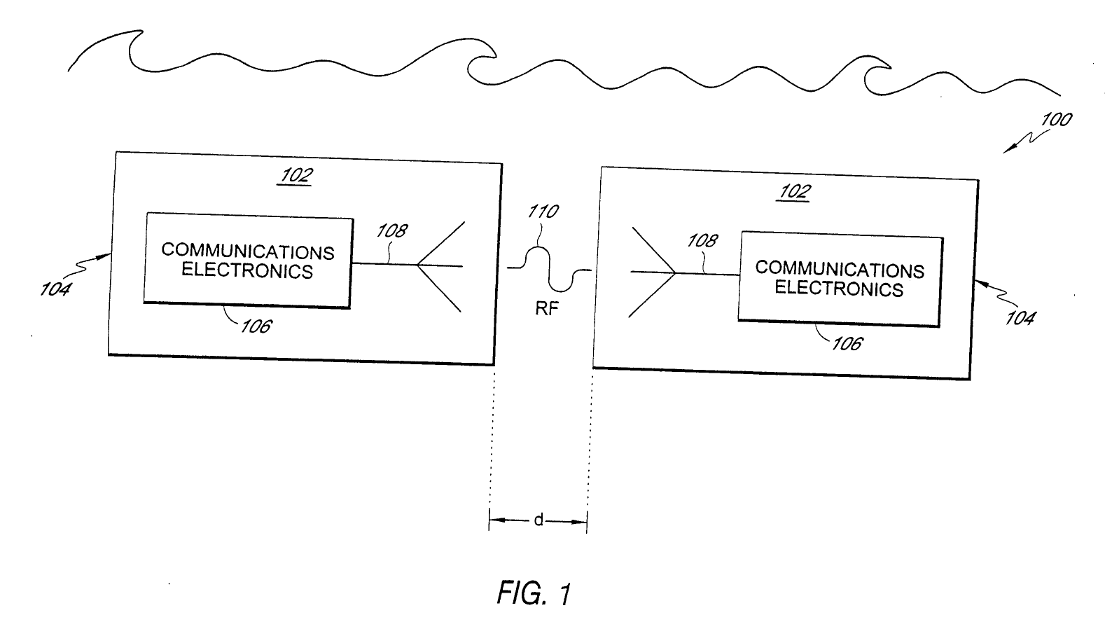

FIG. 1 is a block diagram showing a communications system 100 comprising a plurality of underwater communication devices 102. Each device 102 comprises a housing 104 into which a communications electronics module 106 connected to a radiative element 108, such as an antenna, is enclosed. The housing 104 is generally at least partially formed from a nonmetallic material. The housing 104 protects the internal components from exposure to water. The radiative element 108 may be directional or omnidirectional depending on the application.

The communications module 106 may be a receiver, a transmitter or a transceiver. Other electronics may be enclosed in the housing 104 along with the communications module 106. The module 106 is generally configured for communicating data via digital signals, although embodiments may have analog signal functionality. The module 106 and radiative element 108 are generally configured to operate with RF signals in the approximately 10 kHz to 10 GHZ frequency bands, although other frequencies may be selected. A frequency can be selected according to a desired distance of operation and transmission rates. With these high frequencies, a relatively high volume of data can be communicated with respect to prior methods that use low frequencies.

In the configuration of devices 102 shown in FIG. 1, an RF signal 110 is transmitted through the water between the devices. Because of attenuation, the distance, d, that separates the devices is chosen according to the application. In general, the distance of RF transmission will, depending on the frequency and factors such as the antenna configurations, typically be in the range of about 10 to about 10,000 centimeters. Thus, the technology provides for short range, underwater transmission.

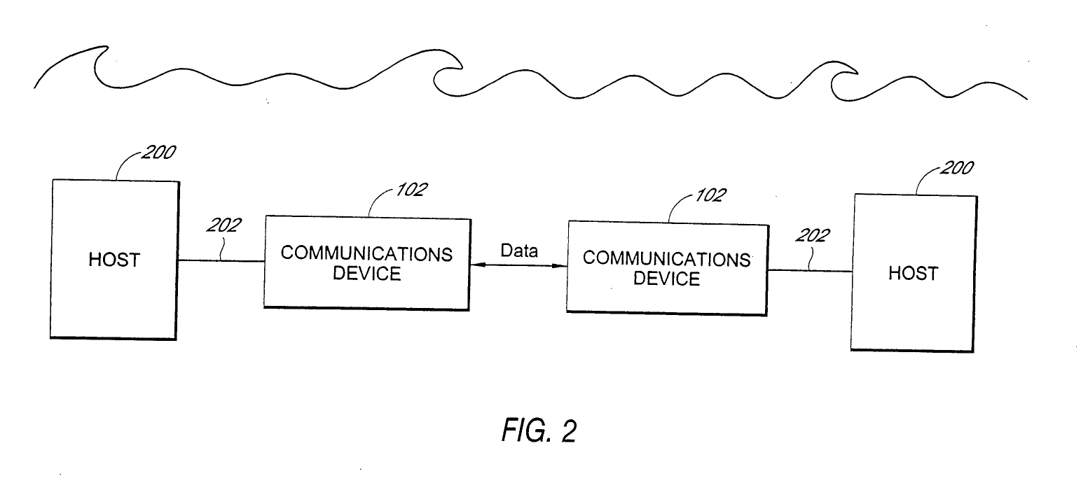

FIG. 2 is a block diagram showing an embodiment where the communication devices 102 are used as a transmission interface between hosts 200. The devices 102 are generally connected by cables 202 to their respective hosts 200. The hosts could be underwater vehicles or systems that perform their own data processing or have data collection capabilities, for example. As in known in the technology, data processing would generally involve a processing device such as, for example, a microprocessor, controller, etc. In certain embodiments, data processing could include collecting data from sensors, storing data in a memory or database, and executing one or more software programs to modify or reformulate the data according to algorithms.

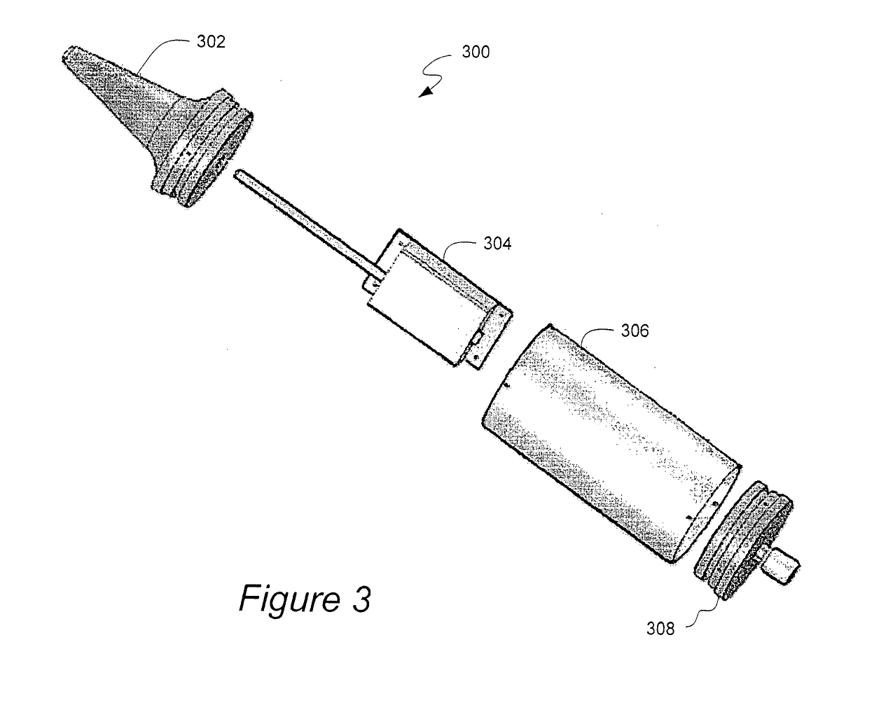

FIG. 3 is an exploded mechanical diagram of one embodiment of the communication device 102. In this embodiment, the device 300 includes a nose piece 302 which mates with a tube 306 using, for instance, an O-ring seal. The other side of the tube 306 mates with a base piece 308. A commercial off-the-shelf wireless packet modem 304 operating at, for instance, a frequency of 900 MHz is inserted in the tube 306 so that the nose piece 302 surrounds the radiative element of the modem 304. The base of the modem 304 includes a communications interface that is wired to the connector which is incorporated in the base piece 308. The connector could be RS-232, USB, or any other suitable interface for transferring data. The housing 104, which in this case is made up of the components 302, 306 and 308 is formed at least partly from a material such as a polymer or plastic including Delrin made by DuPont or PVC, or another suitable nonmetallic, low dielectric strength material. In another embodiment, only the nose piece 302 or a portion of the nose piece 302 is formed from the nonmetallic material so that RF signals can be communicated to and from the radiative element and the water. The connector on the base piece 308 may then be connected with a host via cable and data may be transferred between the device 300 and the connected host. In this embodiment, the modem 304 may transmit and receive data rates of about 10 to about 100 kbps. Of course, higher data transfer rates may be possible in other embodiments.

Embodiments of the technology operate at RF frequencies in the 100s to 1000s of kHz where high data rates are possible and where new transmission methods can be exploited. In this way, data is transmitted underwater using radio waves over short ranges and at high data rates. The changes in wavelength, propagation speed and signal attenuation can be calculated and the radiative element and other transmission components adapted appropriately. In water experiments have demonstrated that a standard 900 MHz packet modem can transmit data at 57 kbps over short distances, for example, about 30 cm. The required radiated power level is only a few hundred milliwatts and has no acoustic signature. In other embodiments, longer distances can be obtained using, for example, lower frequencies or different antenna configurations to produce different radiative patterns. For example, rather than using an omnidirectional radiative pattern, a focused directional pattern can be used to obtain longer distance communication. In one embodiment, such techniques may be used to communicate over distances in the range of multiple meters, for example, one to tens of meters. In one embodiment, an antenna is placed slightly below the surface and radiates freely beyond the air water interface. This allows an underwater transmission into the atmosphere without surface penetration of the antenna.

The combination of low energy requirement (per bit of information) and non-contact data transmission provide a unique underwater communication method for both clandestine and public applications.

Various inventive embodiments have one or more of the following features:
Low power
Clandestine use
High data rates
Impervious to high acoustic noise levels (littoral zone waves and acoustic ‘flow noise’)
Non contact data transmission (no underwater connectors or transducers)
Omni directional
Conductive (no toroid needed)
Works in and out of water
Works through gas, liquid and solid interfaces (at moderate electrical conductivities)

Applications of inventive embodiments may include:
autonomous underwater vehicles
underwater systems
messaging services
divers and swimmers.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. An underwater communications device, comprising:
a radiative element configured to propagate RF signals through water,
a communications section comprising at least one of a receiver and a transmitter, wherein the radiative element communicates RF signals associated with the communications module, and
an at least partially nonmetallic housing to enclose the radiative element and the communications section.

2. The system of claim 1, wherein the communications module provides relatively high speed data for short range transmission.

3. The system of claim 1, wherein the RF signals are propagated through water at UHF or higher frequencies.

4. The system of claim 1, wherein the RF signals are propagated through water in a frequency band in the range of about 10 kHz to about 10 GHz.

5. The system of claim 11, wherein the RF signals associated with the modem provide a data rate in the range of about 10 to about 100 kbps.

6. The system of claim 1, wherein the RF signals are communicated to another device located within about a 30 cm radius.

7. The system of claim 1, wherein the communications section comprises a transceiver.

8. The system of claim 1, wherein the housing is at least partially formed of a polymer.

9. The system of claim 1, wherein the housing is at least partially formed from Delrin or PVC.

10. The system of claim 1, additionally comprising:
an interface for communicating data to a processing device and wherein the processing device is located internally to the housing or externally in a host.

11. An underwater communications device, comprising:
a radiative element configured to propagate RF signals through water,
a modem, wherein the radiative element communicates RF signals associated with the modem, and
an at least partially nonmetallic housing to enclose the radiative element and the modem.

12. The system of claim 11, wherein the communications module provides relatively high speed data for short range transmission.

13. The system of claim 11, wherein the RF signals are propagated through water at UHF or higher frequencies.

14. The system of claim 11, wherein the RF signals are propagated through water in a frequency band in the range of about 10 kHz to about 10 GHz.

15. The system of claim 11, wherein the RF signals are communicated to another device located within about a 30 cm radius.

16. The system of claim 11, wherein the RF signals associated with the modem provide a data rate in the range of about 10 to about 100 kbps.

17. The system of claim 11, wherein the communications section comprises a transceiver.

18. The system of claim 11, wherein the housing is at least partially formed of a polymer.

19. The system of claim 11, wherein the housing is at least partially formed from Delrin or PVC.

20. The system of claim 11, additionally comprising:
an interface for communicating data to a processing device and wherein the processing device is located internally to the housing or externally in a host.

21. A method of underwater data communication, comprising:
transmitting an RF signal within a housing, wherein the transmitted RF signal propagates in water, and
wherein a relatively high data rate is received from the RF signal over a short range.

22. The method of claim 21, wherein the range is about 30 cm.

23. The method of claim 21, wherein the range is about 1 meter to 20 meters.

24. The method of claim 21, wherein the data rate in the range of about 10 to about 100 kbps.

25. A method of underwater data communication, comprising:
receiving an RF signal within a housing, wherein the received RF signal propagates in water, and
wherein a relatively high data rate is transmitted on the RF signal over a short range.

26. The method of claim 26, wherein the range is about 30 cm.

27. The method of claim 26, wherein the data rate in the range of about 10 to about 100 kbps.
